(19) United States
(12) Patent Application Publication
(10) Pub. No.: US 2026/0251224 A1
(43) Pub. Date: Aug. 27, 2026

(54) BI-DIRECTIONAL SAFE CHOKE VALVE

(71) Applicant: SRI ENERGY, INC., Sugar Land, TX (US)

(72) Inventors: Aravindhan Rajamarthandan, Sugar Land, TX (US); Alagarsamy Sundararajan, Sugar Land, TX (US); Sathishkumar Periyasamy, Gangavalli (IN)

(21) Appl. No.: 19/545,073

(22) Filed: Feb. 20, 2026

Related U.S. Application Data
(60) Provisional application No. 63/761,227, filed on Feb. 21, 2025.

(51) Int. Cl. F16K 3/24; F16K 31/53

(52) U.S. Cl. CPC F16K 3/24; F16K 31/53

(57) ABSTRACT

Embodiments include a choke system configured to pass fluids bi-directionally and resist high fluid-pressure bi-directionally.

### PRIORITY CLAIM

This application claims priority to United States Provisional Patent Application No. 63/761,227 filed on February 21, 2025 and entitled “BI-DIRECTIONAL SAFE CHOKE VALVE”, the content of which is hereby incorporated by reference.

### TECHNICAL FIELD

Embodiments of the invention are in the field of oil field equipment and, in particular, choke systems.

### BACKGROUND

A “choke” is a device incorporating an orifice that is used to control fluid flow rate or downstream system pressure. Chokes are available in several configurations for both fixed and adjustable modes of operation. Adjustable chokes enable the fluid flow and pressure parameters to be changed to suit process or production requirements. Fixed chokes do not provide this flexibility, although they are more resistant to erosion under prolonged operation or production of abrasive fluids.

More specifically, an adjustable choke is a valve usually used in well control operations to reduce the pressure of a fluid from high pressure in the closed wellbore to atmospheric pressure. It may be adjusted (opened or closed) to closely control the pressure drop. Adjustable choke valves are constructed to resist wear while high-velocity, solids-laden fluids are flowing by the restricting or sealing elements.

More specifically, a fixed choke is a device used to control the flow of fluids by directing flow through a restriction or hole of a fixed size. The fluid characteristics and the pressure differential across the choke determine the flow rate through a fixed choke.

A “bean choke” is a fixed choke used to control the flow of fluids, usually mounted on or close to a “Christmas tree”. A bean choke contains a replaceable insert, or bean, made from hardened steel or similar durable material. The insert is manufactured with a precise diameter hole that forms the choke through which all fluids must pass. Choke inserts are available in a range of sizes, generally identified by choke diameter stated in 64ths of an inch; for example, a "32 bean" is equivalent to a 1/2-in. choke diameter.

A “choke line” is a high-pressure pipe leading from an outlet on the blow out preventer (BOP) stack to the backpressure choke and associated manifold. During well-control operations, the fluid under pressure in the wellbore flows out of the well through the choke line to the choke, reducing the fluid pressure to atmospheric pressure. In floating offshore operations, the choke and kill lines exit the subsea BOP stack and then run along the outside of the drilling riser to the surface. The volumetric and frictional effects of these long choke and kill lines must be considered to control the well properly.

A “choke manifold” includes a set of valves (e.g., high-pressure valves) and associated piping that may include at least two adjustable chokes, arranged such that one adjustable choke may be isolated and taken out of service for repair and refurbishment while well flow is directed through the other one.

### BRIEF DESCRIPTION OF THE DRAWINGS

Features and advantages of embodiments of the present invention will become apparent from the appended claims, the following detailed description of one or more example embodiments, and the corresponding figures. Where considered appropriate, reference labels have been repeated among the figures to indicate corresponding or analogous elements.

FIG. 1A depicts a traditional uni-directional choke. FIG. 1B depicts an embodiment of a bi-directional choke that avoids uneven bending moments at the actuator/choke coupling.

FIGS. 2A-2B depict a traditional uni-directional choke. FIGS. 2C-2D depicts an embodiment of a bi-directional choke that avoids uneven bending moments at the actuator/choke coupling.

FIG. 3A depicts forces experienced by an embodiment during normal loading conditions. FIG. 3B depicts forces experienced by an embodiment during abnormal loading conditions. FIGS. 3C-3D depicts equidistant anchor distribution to accommodate the forces experienced during the abnormal loading of FIG. 3B. FIGS. 3E-3F depicts non-equidistant anchor distribution which often fail to accommodate the forces (e.g., see arrow indicating moment generated by upward force during reverse flow) experienced during the abnormal loading of FIG. 3B.

FIGS. 4A-4B address an embodiment of a worm gear shaft having a portion with a non-circular perimeter that prevents rotation of the work gear shaft. FIGS. 4C-4D depict an embodiment of a bi-directional choke that avoids uneven bending moments at the actuator/choke coupling.

FIG. 5 provides an embodiment of a method of disassembling a choke assembly without having to completely disassemble the choke in doing so.

FIG. 6A provides an embodiment of a front retainer having a pressure-equalization passage. FIG. 6B provides an embodiment of an operating stem having a pressure-equalization passage. FIG. 6C provides an embodiment of a gate and operating stem each having a pressure-equalization passage. FIG. 6D provides an embodiment of a bonnet and choke body each having a pressure-equalization passage. Such passages help prevent dangerous pressure-lock situations that may endanger users during disassembly of the system. Further, such passages may avoid pressure differentials across, for example, the gate, which can necessitate a larger operator/actuator to overcome the pressure differential.

FIG. 7A provides an embodiment of a visual mechanical gauge combined with a transmitter, each of which indicates whether the choke is open, closed, or at a position between open and closed. FIG. 7B shoes the same visual mechanical gauge coupled to a digital mill connector.

FIGS. 8A, 8B, 8C provide elevation, side, and isometric views of an embodiment of a bi-directional choke that avoids uneven bending moments at the actuator/choke coupling in addition to a mechanical visual indicator that indicates whether the gate is open, closed, or somewhere in between.

FIGS. 9A, 9B provide sectional elevation and isometric views of an embodiment of a bi-directional choke that avoids uneven bending moments at the actuator/choke coupling in addition to a mechanical visual indicator that indicates whether the gate is open, closed, or somewhere in between.

FIGS. 10A, 10B provide elevation and sectional views of an embodiment of a bi-directional choke that avoids uneven bending moments at the actuator/choke coupling in addition to a mechanical visual indicator that indicates whether the gate is open, closed, or somewhere in between.

FIGS. 11A, 11B provide side and sectional views of an embodiment of a bi-directional choke that avoids uneven bending moments at the actuator/choke coupling in addition to a mechanical visual indicator that indicates whether the gate is open, closed, or somewhere in between.

FIGS. 12A, 12B provide plan and sectional views of an embodiment of a bi-directional choke that avoids uneven bending moments at the actuator/choke coupling in addition to a mechanical visual indicator that indicates whether the gate is open, closed, or somewhere in between.

FIGS. 13A, 13B provide sectional elevation and isometric views of an embodiment of a bi-directional choke that avoids uneven bending moments at the actuator/choke coupling in addition to a mechanical visual indicator that indicates whether the gate is open, closed, or somewhere in between.

FIG. 14 provides as sectional elevation view of an embodiment of a bi-directional choke that avoids uneven bending moments at the actuator/choke coupling in addition to a mechanical visual indicator that indicates whether the gate is open, closed, or somewhere in between.

FIGS. 15A, 15B, 15C, 15D provide plan, elevation, side, and isometric views of an embodiment of a bi-directional choke that avoids uneven bending moments at the actuator/choke coupling in addition to a mechanical visual indicator that indicates whether the gate is open, closed, or somewhere in between.

FIG. 16 provides a plan view of a conventional choke that is subject to uneven bending moments at the actuator/choke coupling.

FIG. 17 provides a sectional view of an embodiment of a valve stem and gate each having a pressure-equalization passage.

FIG. 18 provides a system that includes an embodiment of a choke system.

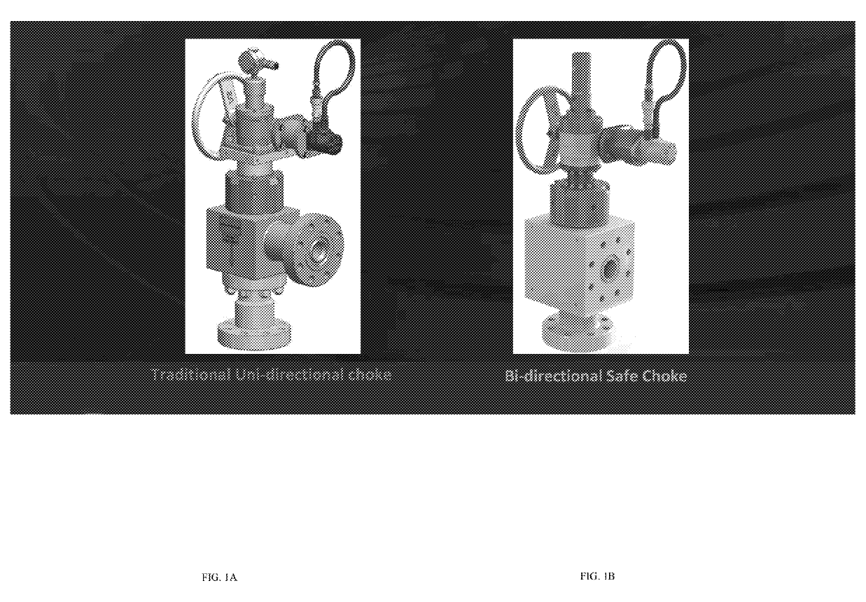

### DETAILED DESCRIPTION

Reference will now be made to the drawings wherein like structures may be provided with like suffix reference designations. In order to show the structures of various embodiments more clearly, the drawings included herein are diagrammatic representations of structures. Thus, the actual appearance of the fabricated structures, for example in a photo, may appear different while still incorporating the claimed structures of the illustrated embodiments. Moreover, the drawings may only show the structures useful to understand the illustrated embodiments. Additional structures known in the art may not have been included to maintain the clarity of the drawings. “An embodiment”, “various embodiments” and the like indicate embodiment(s) so described may include particular features, structures, or characteristics, but not every embodiment necessarily includes the particular features, structures, or characteristics. Some embodiments may have some, all, or none of the features described for other embodiments. “First”, “second”, “third” and the like describe a common object and indicate different instances of like objects are being referred to. Such adjectives do not imply objects so described must be in a given sequence, either temporally, spatially, in ranking, or in any other manner. “Connected” may indicate elements are in direct physical or electrical contact with each other and “coupled” may indicate elements co-operate or interact with each other, but they may or may not be in direct physical or electrical contact.

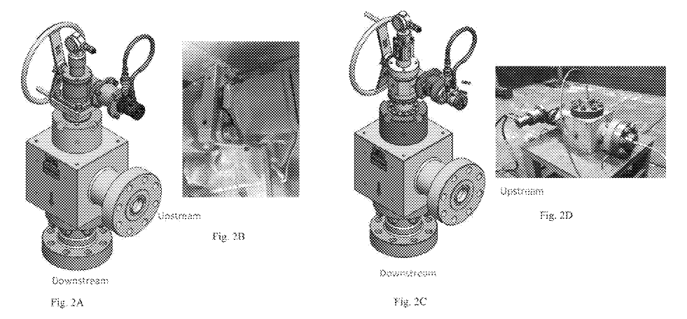

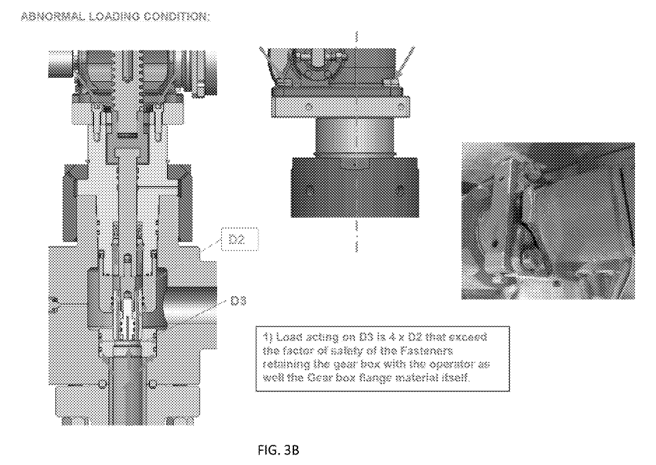

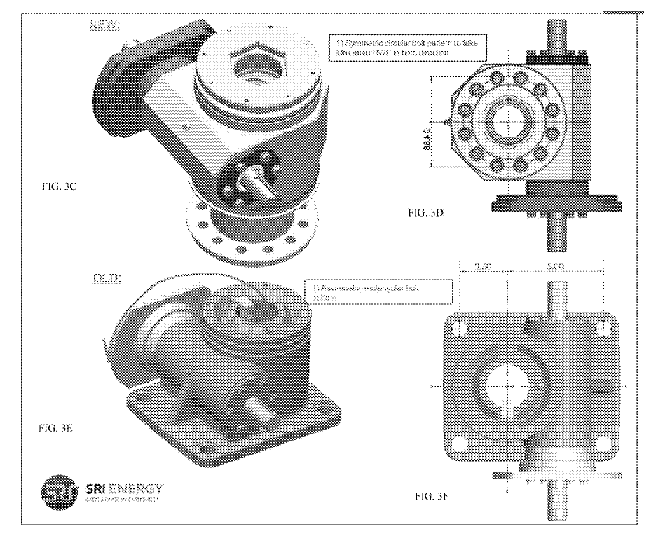

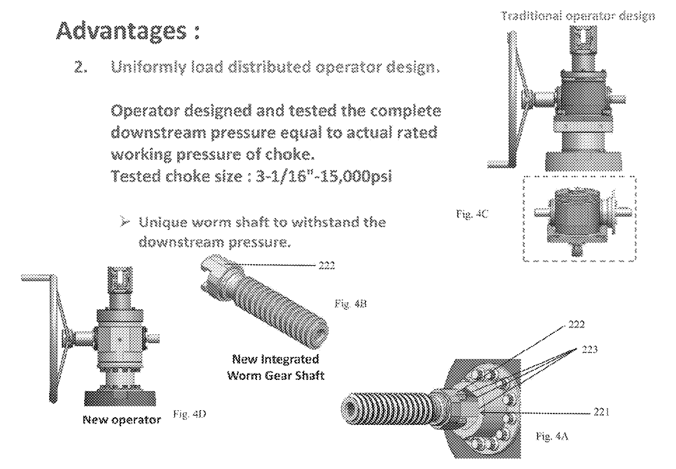

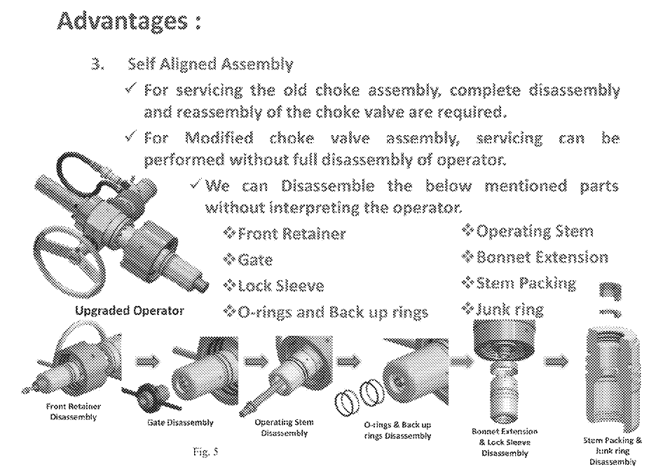

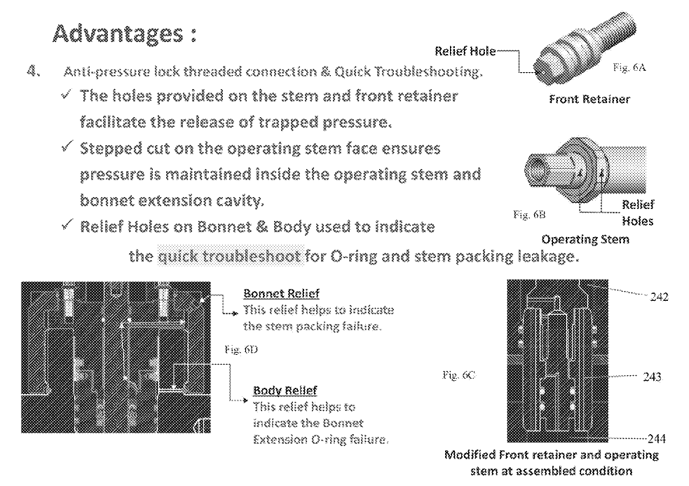

Applicant determined conventional choke systems may be unable to handle “reverse flow” when the choke is closed without suffering failure. However, embodiments described herein address this issue. Through various measures described herein, a more robust choke system is provided that can better withstand forces such as those encountered during reverse flow with the choke closed. First, a portion of the gear system no longer requires the gear box to be coupled to the choke body in such a way that uneven bending moments are generated causing anchors to fail (e.g., see FIGS. 2A-2D). This improvement leads to uniform load distribution corresponding to the choke actuator/operator. Second, a more robust, monolithic, worm gear element (and corresponding conduit) with non-circular circumference helps better withstand torque and/or pressure from reverse flow (e.g., see FIGS. 4A-4B). Third, ease of use is fostered with elements that no longer require the actuator/operator to be disassembled in order to service the choke body (e.g., FIG. 5). Fourth, various elements (e.g., retainers, stems, and, more generally, rods) have channels to help equilibrate/relieve pressure and/or indicate where elements, such as seals, are failing (e.g., see FIGS. 6A-6D, FIG. 14, and FIG. 17). Fifth, protection from adverse conductions is promoted with strategic placement of seals (e.g., O-rings, wiper seals available from, for example, https://www.fpeseals.com/seals/wiper-seals). Sixth, anchor securement of choke open/close transmitter units is simplified. Seventh, a visible mechanical open/close indicator is supplied in addition to any transmitter regarding open/close status (e.g., see FIGS. 7A-7B). As a result, a failure to properly “zero” or “tare” the transmitter is overcome by visual inspection of the mechanical indicator/gauge. The indicator may indicate multiple positions such as open, closed, and various intermediate stages between the open and closed stages.

Examples follow to better illustrate various embodiments.

### EXAMPLE SET 1

Example 1. A choke system comprising a choke body (201) including an input channel (202), an output channel (203), a seat (204), and a gate (205). The system further includes a valve stem (206) coupled to the gate and a choke valve actuator (207) coupled to the valve stem. The seat includes a seat channel (209) that couples the input channel to the output channel. In an open configuration the choke system is to convey fluid through the seat channel when the gate is not engaged with the seat and fluid is pressurized in at least one of the input channel or the output channel. In a closed configuration the choke system is to prevent the conveyance of fluid through the seat channel when the gate is engaged with the seat.

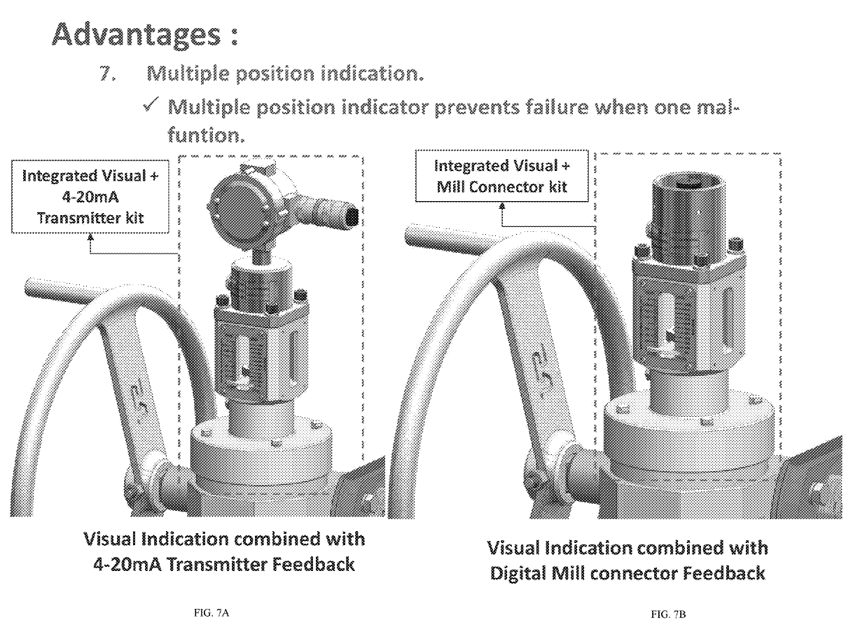

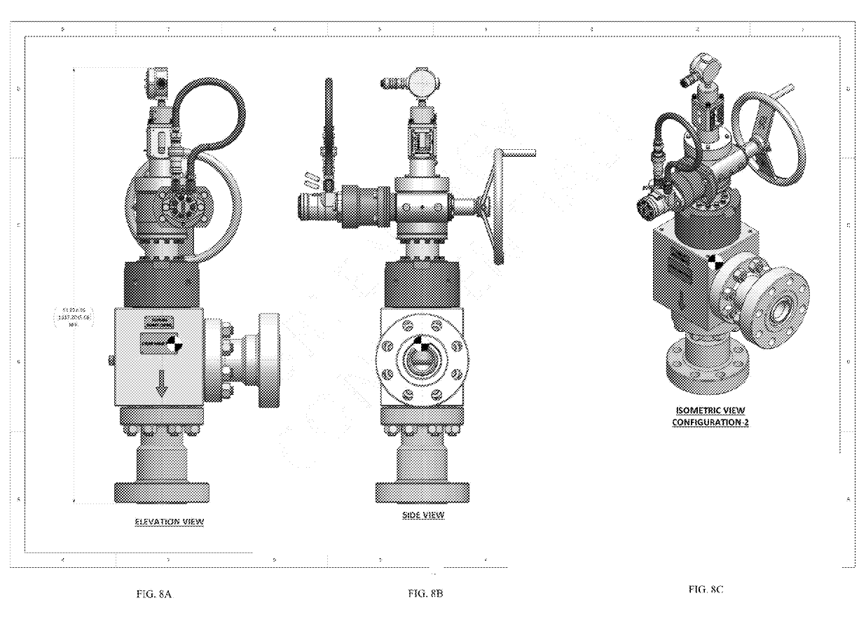

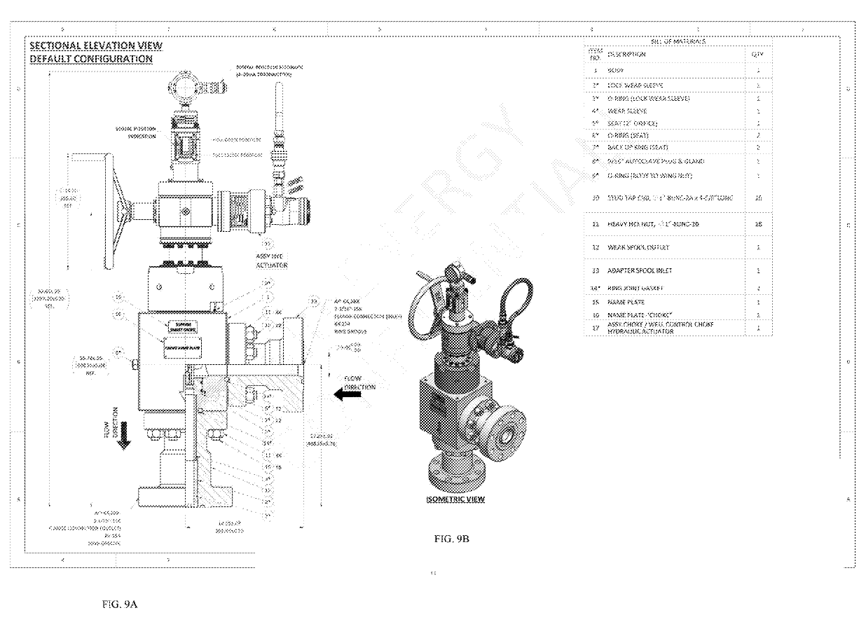

As used herein, a fluid includes a liquid, gas, or combinations thereof. FIG. 10B illustrates a “closed configuration” with the seat blocking flow through the choke body. In another embodiment, the “input channel” is a “first channel” and the “output channel” is a “second channel” to emphasize the channels, whether deemed “first” or “input”, may allow fluid flow in any direction. As used herein, a “choke valve actuator” may also be known as a “choke valve operator”.

Example 2. The system of example 1 comprising a first rod (210), wherein: the first rod is at least partially threaded and the first rod couples the choke valve actuator to the valve stem. In the open configuration the first rod is withdrawn away from the seat to withdraw the gate from the seat. In the closed configuration the first rod is advanced towards the seat to engage the gate with the seat.

Thus, the first rod moves up and down along axis 216 to respectively open and close the choke.

Example 3. The system of example 2, wherein the choke valve actuator includes a worm drive.

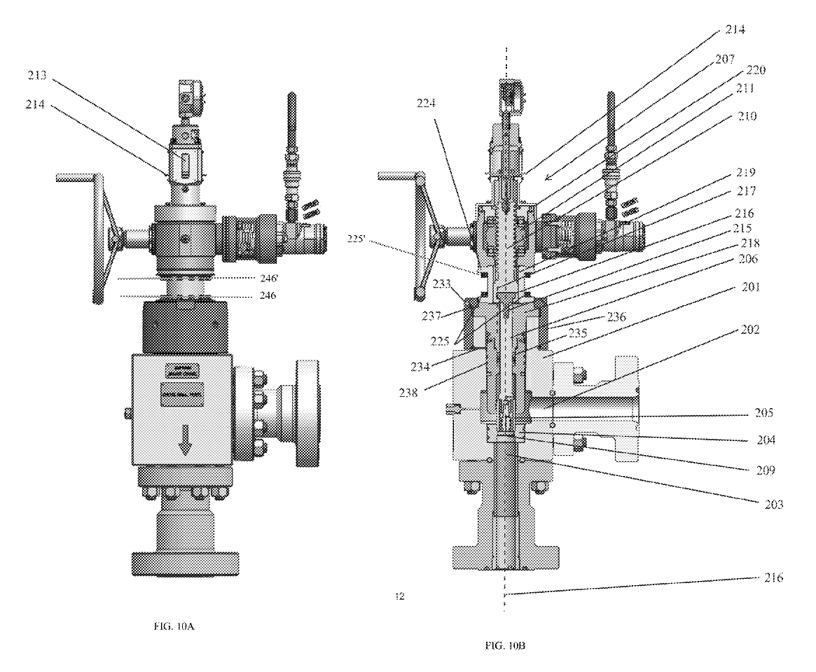

For example, the worm drive may include an assembly of wheel(s), screw(s), and the like. See, e.g., elements 211, 212 (e.g., FIGS. 10B and 11B) which collectively couple to first rod 210 to move rod 210 up/down to open/close the gate.

Example 4. The system according to any of examples 2-3, comprising: a housing having a window (213) and a mechanical gauge (214). In the open configuration the mechanical gauge is withdrawn away from the seat to visually indicate, via the window, the choke system is in the open configuration. In the closed configuration the mechanical gauge is advanced towards the seat to engage the gate with the seat to visually indicate, via the window, the choke system is in the closed configuration.

For example, in FIG. 10A the gauge is shown low in window 213 to indicate a closed gate. But as the first rod, and therefore the gauge, rises away from the seat the gauge will rise in the window to indicate the system is in an open configuration.

Example 5. The system according to any of examples 2-4 comprising a second rod (215) that couples the first rod to the valve stem.

Example 6. The system of example 5 wherein the second rod couples to the first rod via a “T” joint (216).

Example 7. The system of example 5 wherein the second rod couples to the first rod via a dynamic joint.

In an embodiment the system of FIG. 10B includes second rod (i.e., a stem coupling) 215 that couples first rod 210 to valve stem 206. See, for example, the “T” joint of FIG. 10B. The stem coupling allows the upper end of the valve stem 206 to dynamically engage the lower end of first rod 210. In other words, the “dynamic” nature allows “give” or some movement, unlike a “static” coupling such as a threaded coupling.

In an embodiment, the valve stem includes long axis 216. Additional axis 217 is parallel to the long axis. Additional axis 217 intersects the first rod on either side of a branch of the “T” joint of rod 206. The “T” may be formed on first rod 210 instead of on rod 206.

Stem 206 is “floating” or “dynamically engaged” because the “T” member 216 inserts into a slot of first rod 210 with a coupling that allows the stem some movement (i.e., to float or be dynamic). This helps alleviate concerns with imprecisely aligned stem and related components. For example, when elements 210, 216, 206 are coupled together, but not well aligned along axis 216, this can cause undesirable resistance (e.g., within bonnet 218) when opening/closing the choke.

As used herein, a “rod” may be solid, hollow, have a channel that traverses a length of the rod, have voids within the rod, and the like. Thus, a “rod” may be a “hollow rod” (like a hollow pipe) or a solid rod.

Example 8. The system of example 5 wherein the first rod includes a threaded upper end and a non-threaded lower end, the non-threaded lower end of the first rod being between the threaded upper end of the first rod and the gate. The second rod includes an upper end and a lower end, the lower end of the non-first rod being between the upper end of the second rod and the gate. A first axis includes a long axis of the valve stem. A second axis is parallel to the first axis. The second axis intersects the upper end of the second rod at a first location and the non-threaded lower end of the first rod at second and third locations. The first location is between the second and third locations.

Example 9. The system according to any of examples 2-7 comprising a conduit (219) and a gear box (220). The first rod is partially included in the conduit. The first rod is partially included in the gear box. The conduit couples the gear box to the choke body. The conduit includes a channel having a non-circular circumference (221). The first rod includes a non-threaded portion having a circumference (222) that pattern matches the non-circular circumference of the channel of the conduit.

For example, see FIGS. 4A, 4B. The pattern matching circumferences help lower forces (e.g., torque) that may be experienced by rod 210 during raising/lowering of rod 210.

Example 10. The system of example 9, wherein the first rod has a threaded portion that is monolithic with the non-threaded portion of the first rod.

For example, see FIG. 4B. Such a unity of formation may better resist damaging forces put upon rod 210 when, for example, rod 210 moves up/down to open/close the choke.

Example 11. The system of example 9, wherein the non-circular circumference includes first, second, and third linear portions (223) that are not co-linear with one another. The second linear portion directly interfaces the first and third linear portions.

See, for example, the linear portions in FIG. 4A that will couple to flat faces of the rod in FIG. 4B.

Example 12. The system according to any of examples 2-7 comprising a conduit (219), a flange (224), and a gear box (220). The first rod is partially included in the conduit. The first rod is partially included in the gear box. The conduit couples the gear box to the choke body. The flange couples the conduit to the gear box. The gearbox is coupled to the flange via anchors (225). A first axis (216) includes a long axis of the valve stem. The anchors are equidistant from the first rod along a plane that is orthogonal to the first axis.

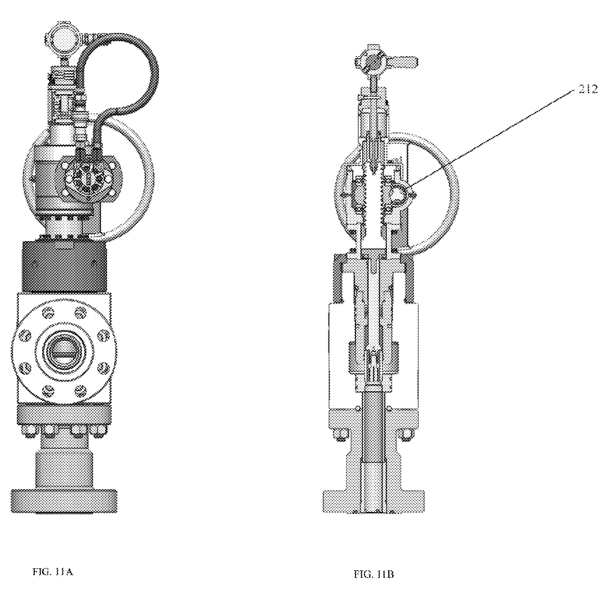

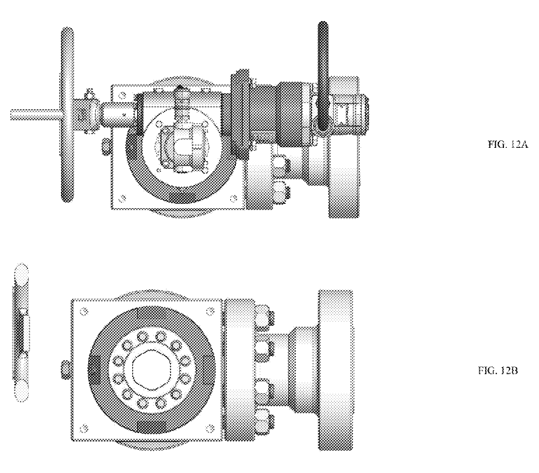

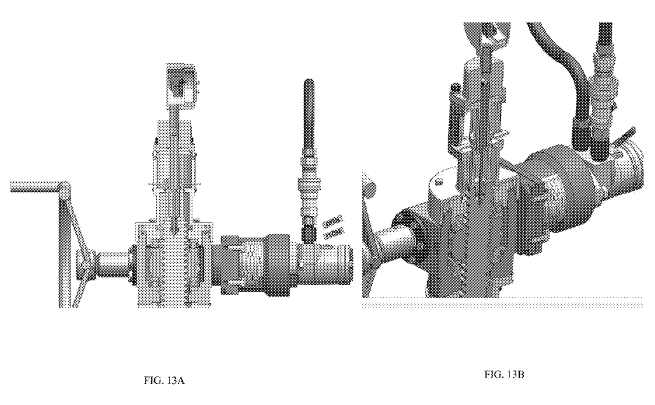

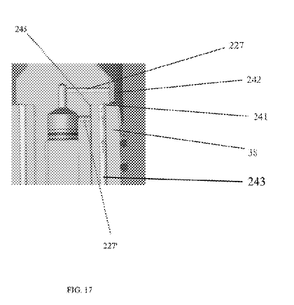

See also the conventional arrangement of FIGS. 12A and 16. Because of the location of gear housing 226’, the anchors 225’ are not equidistant from “from the first rod along a plane that is orthogonal to the first axis” (216). However, in embodiments such as FIG. 11A or FIG. 12B the anchors are equidistant from where the hidden first rod would be. This helps remove uneven bending forces that may be applied (perhaps mistakenly) to the anchors when pressure is reversed in the choke (applied from downstream while choke is closed), thereby avoiding failures such as those shown in FIG. 2B (which shows fractures nearest the first rod but which does not show anchors farthest from the first rod are completely sheared off due to their being subjected to higher bending forced due to the longer moment arm from the first rod to those anchors).

This arrangement helps the distribute the load (e.g., from reverse flow) evenly and avoid uneven bending moments, that can lead to failure of anchors or, more generally, the coupling between an actuator/operator and the choke body. This makes the system “bi-directionally safe” because the system is can withstand heightened forces generated during reverse flow into the choke.

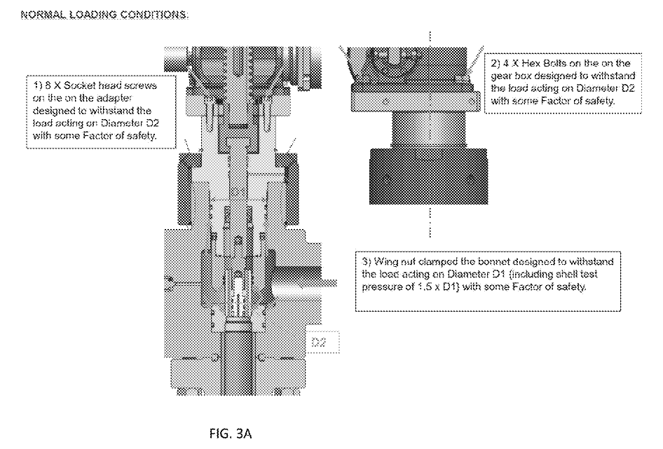

As a further example, FIG. 3A shows normal loading conditions on an embodiment that does not employ anchors that equidistant from a central axis of the choke system. The system has components (e.g., “4 X Hex Bolts”) designed to withstand forces generated on, for example, D1 and/or D2 (Force = Pressure * Area). However, FIG. 3B shows what can happen when flow is reversed. The force is higher due to, for example, the increased area at D3 (for which the system was not designed). This can lead to high bending moment (see, e.g., arrow in FIG. 3E) that can shear or otherwise cause anchors (which couple the valve body to the actuator) and plates to fail.

Another version of example 12. The system according to any of examples 2-7 comprising a conduit (219), a flange (224), and a gear box (220). The first rod is partially included in the conduit. The first rod is partially included in the gear box. The conduit couples the gear box to the choke body. The flange couples the conduit to the gear box. The gearbox is coupled to the flange via a plurality of anchors (225) and no other anchors couple the gearbox to the flange. A first axis (216) includes a long axis of the valve stem. The plurality of anchors is equidistant from the first rod along a plane that is orthogonal to the first axis.

Example 13. The system according to any of examples 1-12, wherein the valve stem includes a valve stem channel (227), a valve stem first aperture (228), and a valve stem second aperture (229). The valve stem channel couples the valve stem first aperture to the valve stem second aperture. The valve stem channel is hollow. The valve stem second aperture is in a sidewall of the valve stem.

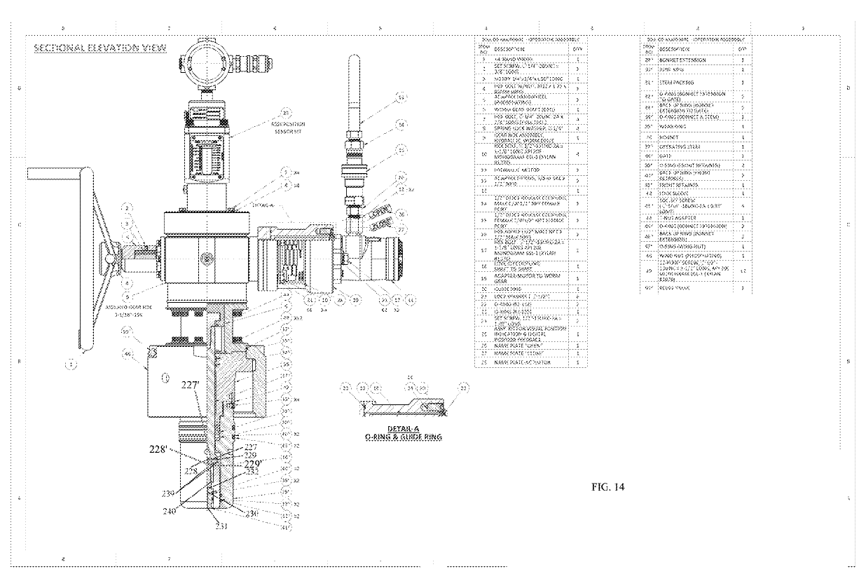

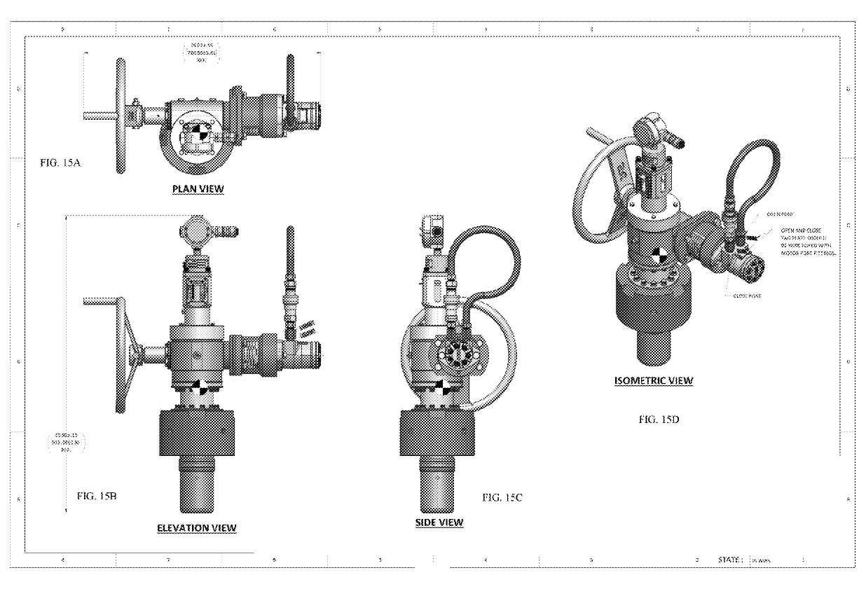

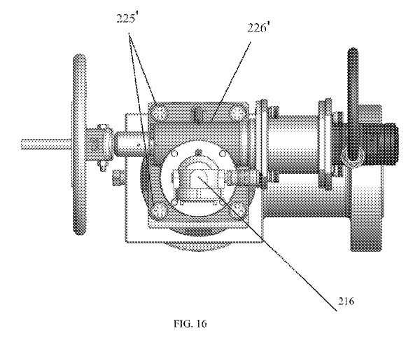

See, for example, FIG. 14. The holes/apertures facilitate release of trapped pressure to better enable, for example, disassembly of the system. See also FIGS. 6A, 6B, 6C, 6D, 14, 17. For example, the channel may help alleviate relatively high or low pressure in voids 239.

Example 13.1 The system of example 13, wherein the valve stem includes an valve stem additional channel (227’), a valve stem additional first aperture (228), and a valve stem additional second aperture (229). The valve stem additional channel couples the valve stem additional first aperture to the valve stem additional second aperture. The valve stem additional channel is hollow. The valve stem additional second aperture is in a sidewall of the valve stem.

The additional channel 227’ further helps with pressure equalization between different zones of the stem assembly, thereby reducing the need for larger actuators/operators to move the gate between open and closed positions.

Example 13.2 The system of example 13.1, wherein: the valve stem includes outer portions that join at a junction location (245). The outer portions join at the junction location at an angle that is between 85 and 95 degrees. The junction is between the valve stem second aperture and the valve stem additional second aperture.

The stepped area at the junction location ensures pressure is maintained inside the operation stem and bonnet cavity.

Example 13.3 The system of example 13.2, wherein the junction location is within 5 mm of the gate.

Example 14. The system according to any of examples 1-13.2 comprising an additional rod (41) that couples the valve stem to the gate (38 in FIG. 14). The additional rod includes an additional rod channel (230), an additional rod first aperture (231), and an additional rod second aperture (232). The additional rod channel couples the additional rod first aperture to the additional rod second aperture. The additional rod channel is hollow. The additional rod second aperture is in a sidewall of the additional rod.

See, for example, FIG. 14. The holes/apertures facilitate release of trapped pressure to better enable, for example, disassembly of the system. See also FIGS. 6B and 6C. For example, the channel may help alleviate relatively high or low pressure in void 240.

Another version of example 14. The system according to any of examples 1-13 comprising an additional rod (41) threadingly coupled to the valve stem, wherein the additional rod includes an additional rod channel (230), an additional rod first aperture (231), and an additional rod second aperture (232). The additional rod channel couples the additional rod first aperture to the additional rod second aperture. The additional rod channel is hollow. The additional rod second aperture is in a sidewall of the additional rod.

Another version of example 14. The system according to any of examples 1-13 comprising an additional rod (41) threadingly coupled to the valve stem, wherein: the additional rod includes an additional rod channel (230), an additional rod first aperture (231), and an additional rod second aperture (232). The additional rod channel couples the additional rod first aperture to the additional rod second aperture. The additional rod channel is hollow.

Example 15. The system according to any of examples 1-14 comprising: stem packing (235) in contact with the valve stem and a cylinder (236) coupled to the choke body. The cylinder includes a cylinder channel (237), a cylinder first aperture, and a cylinder second aperture. The cylinder channel couples the cylinder first aperture to the cylinder second aperture. The cylinder channel is hollow. The cylinder first aperture fluidly couples the stem packing to the cylinder channel. The cylinder second aperture is in a sidewall of the cylinder. See plug 233 in the second aperture.

See, for example, FIG. 10B. See also FIGS. 6A-6D, describing body and/or bonnet relief (which helps to indicate stem packing 235 failure).

Example 16. The system according to any of examples 1-15 comprising a choke body seal, wherein: the choke body seal (238) directly contacts an inner wall of the choke body (201). The choke body includes a choke body channel (234), a choke body first aperture, and a choke body second aperture. The choke body channel couples the choke body first aperture to the choke body second aperture. The choke body channel is hollow. The choke body first aperture fluidly couples the choke body seal to the choke body channel. The choke body second aperture is in a sidewall of the choke body.

See, for example, FIG. 10B. See also FIGS. 6A-6D, describing body and/or bonnet relief (which helps to indicate an O-ring 238 (adjacent bonnet extension 29 of FIG. 14) failure for quick troubleshooting).

Example 17. The system according to any of examples 1-16, wherein: the gate (38) includes a gate channel (243) that traverses the gate and terminates at a gate channel aperture (241). The gate channel aperture is within 5 mm of a portion of the valve stem. At least a portion of the gate channel aperture is not blocked by the valve stem or any other component of the system. No portion of the valve stem is included in the gate channel.

See, e.g., arrows of FIG. 17 showing a fluid path that is not blocked by the valve stem or any other component of the system. FIG. 6C also shows a gate with a channel (243) included in the wall of the gate.

In the embodiments of FIGS. 6C and 19, when the gate is shouldered on the valve stem, there is a chance the stem and gate may make a tight seal between them that prevents pressure from getting into area 242 behind the gate, which may result in a pressure differential between areas 242 and 244.

For example, when area 244 has 10,000 psi and the stem seals securely on the gate (so area 242 is 0 psi), the user may need to move the gate against 10,000 psi. That differential pressure may require the user to use a large actuator/operator (e.g., hydraulic, electric, manual, or combinations thereof) to move the gate up and down against the pressure.

However, in a scenario when area 244 has 10,000 psi, but pressure travels through channel 243, then through the stepped face on the valve stem at location 241, and into area 242. Pressure would equalize between areas 242, 244, thereby making it easier for the user to move the gate up and down (thereby negating the need for a larger actuator/operator).

Another version of example 17. The system according to any of examples 1-16, wherein: the gate (38) includes a gate channel (243) in a wall of the gate, the gate channel traversing the gate and terminating at a gate channel aperture (241). The gate channel aperture is within 5 mm of a portion of the valve stem.

Example 18. The system of example 17, wherein at least a portion of the gate channel aperture is blocked by the valve stem or any other component of the system.

See, for example, FIG. 17. The aperture facilitates release of trapped pressure to better enable, for example, disassembly of the system. For example, the channel may help alleviate relatively high or low pressure in voids 242.

Example 19. A manifold including: the system according to any of examples 1-18; at least one gate valve; at least one additional choke.

Example 20. The system according to any of examples 1-19 comprising: a retainer; a lock sleeve; at least one seal; a bonnet extension; a stem packing seal; and a junk ring.

Example 21. A method comprising, without dissembling the choke valve actuator, removing from the system of example 20 at least one of the following: the retainer, the gate, the valve stem, the lock sleeve, the at least one seal, the bonnet extension, the stem packing seal, the junk ring, or combinations thereof.

See, e.g., FIG. 5.

Example 22. A method comprising, without disassembling the system of example 15, determining the stem packing is leaking fluid.

Example 23. A method comprising, without disassembling the system of example 16, determining the choke body seal is leaking fluid.

### EXAMPLE SET 2

Example 1. A choke system comprising: a choke body (201) including an input channel (202), an output channel (203), a seat (204), and a gate (205); a valve stem (206) coupled to the gate; a choke valve actuator (207); a threaded first rod (210) that couples the choke valve actuator to the valve stem; a plurality of anchors (225) that couple the choke valve actuator to the choke body; wherein a first axis (216) is colinear with a long axis of the valve stem; wherein the seat includes a seat channel (209) that couples the input channel to the output channel; wherein the plurality of anchors includes at least four anchors that are equidistant from the first axis in a plane (246) that is orthogonal to the first axis.

Example 2. The system of example 1 comprising a conduit (219) that couples the choke valve actuator to the choke body, wherein: the conduit includes a flange (224); the first rod is at least partially included in both the choke valve actuator and the conduit; the choke body is coupled to the flange via the plurality of anchors and no other anchors couple the flange to the choke body.

Example 3. The system of example 2, wherein: the conduit includes an additional flange; the choke valve actuator is coupled to the additional flange via an additional plurality of anchors (225’) and no other anchors couple the additional flange to the choke valve actuator; the additional plurality of anchors includes at least four anchors that are equidistant from the first axis in an additional plane (246’) that is orthogonal to the first axis.

Example 4. The system according to any of examples 2-3, wherein: the conduit includes a channel having a non-circular circumference (221); the first rod includes a non-threaded portion having a circumference (222) that pattern matches the non-circular circumference of the channel of the conduit.

Example 5. The system of example 4, wherein: the non-circular circumference includes first, second, and third linear portions (223) that are not co-linear with one another; the second linear portion directly interfaces the first and third linear portions.

Example 6. The system according to any of example 1-5, wherein: the choke valve actuator includes a worm drive; the first rod is a part of the worm drive.

Example 7. The system according to any of examples 1-6, comprising: a housing having a window (213); a mechanical gauge (214); wherein the mechanical gauge is: (a) withdrawn away from the seat to visually indicate, via the window, the choke system is in an open configuration, (b) advanced towards the seat to engage the gate with the seat to visually indicate, via the window, the choke system is in a closed configuration.

Example 8. The system according to any of examples 1-7 comprising a second rod (215) that couples the first rod to the valve stem.

Example 9. The system of example 8, wherein: the first rod includes a threaded upper end and a non-threaded lower end, the non-threaded lower end of the first rod being between the threaded upper end of the first rod and the gate; the second rod includes an upper end and a lower end, the lower end of the non-first rod being between the upper end of the second rod and the gate; and a second axis is parallel to the first axis; the second axis intersects the upper end of the second rod at a first location and the non-threaded lower end of the first rod at second and third locations; and the first location is between the second and third locations.

Example 10. The system according to any of examples 1-9, wherein: the valve stem includes a valve stem channel (227), a valve stem first aperture (228), and a valve stem second aperture (229); the valve stem channel couples the valve stem first aperture to the valve stem second aperture; the valve stem channel is hollow; the valve stem second aperture is in a sidewall of the valve stem.

Example 11. The system of example 10, wherein: the valve stem includes an valve stem additional channel (227’), a valve stem additional first aperture (228), and a valve stem additional second aperture (229); the valve stem additional channel couples the valve stem additional first aperture to the valve stem additional second aperture; the valve stem additional channel is hollow; the valve stem additional second aperture is in a sidewall of the valve stem.

Example 12. The system of example 11, wherein: the valve stem includes outer portions that join at a junction location (245); the outer portions join at the junction location at an angle that is between 85 and 95 degrees; the junction is between the valve stem second aperture and the valve stem additional second aperture.

Example 13. The system of example 12, wherein the junction location is within 5 mm of the gate.

Example 14. The system according to any of examples 1-13 comprising an additional rod (41) threadingly coupled to the valve stem, wherein: the additional rod includes an additional rod channel (230), an additional rod first aperture (231), and an additional rod second aperture (232); the additional rod channel couples the additional rod first aperture to the additional rod second aperture; the additional rod channel is hollow; the additional rod second aperture is in a sidewall of the additional rod.

Example 15. The system according to any of examples 1-14 comprising: stem packing (235) in contact with the valve stem; a choke body cylinder (236) that includes at least a portion of the valve stem, a cylinder channel (237), a cylinder first aperture, and a cylinder second aperture; the cylinder channel couples the cylinder first aperture to the cylinder second aperture; the cylinder channel is hollow; the cylinder first aperture fluidly couples the stem packing to the cylinder channel; the cylinder second aperture is in a sidewall of the choke body cylinder.

Example 16. The system according to any of examples 1-15 comprising a choke body seal, wherein: the choke body seal (238) directly contacts an inner wall of the choke body (201); the choke body includes a choke body channel (234), a choke body first aperture, and a choke body second aperture; the choke body channel couples the choke body first aperture to the choke body second aperture; the choke body channel is hollow; the choke body first aperture fluidly couples the choke body seal to the choke body channel; the choke body second aperture is in a sidewall of the choke body.

Example 17. The system according to any of examples 1-16, wherein: the gate (38) includes a gate channel (243) that traverses the gate and terminates at a gate channel aperture (241); the gate channel aperture is within 5 mm of a portion of the valve stem; at least a portion of the gate channel aperture is not blocked by the valve stem or any other component of the system; no portion of the valve stem is included in the gate channel.

Example 18. The system according to any of examples 1-16, wherein: the gate (38) includes a gate channel (243) in a wall of the gate, the gate channel traversing the gate and terminating at a gate channel aperture (241); the gate channel aperture is within 5 mm of a portion of the valve stem.

Example 19. The system according to any of examples 17-18, wherein at least a portion of the gate channel aperture is blocked by the valve stem or any other component of the system.

Example 20. The system according to any of examples 1-19 comprising: at least one gate valve coupled to the choke body; at least one additional choke coupled to the choke body.

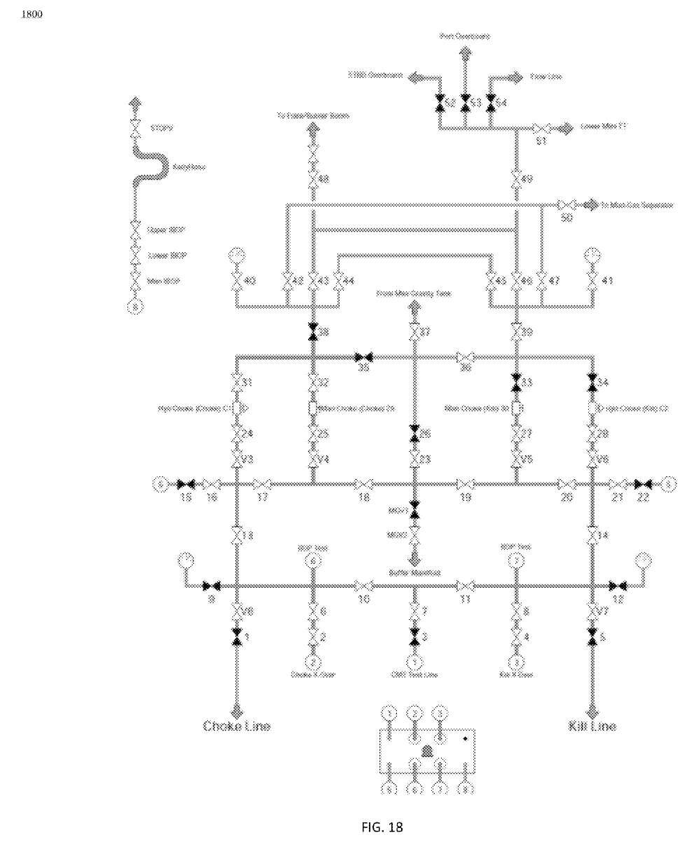

For example, the system may be included in the system 1800 of FIG. 18. The choke of examples 1-19 may be located at, for example, choke “C1”. The parts of large systems may be sold or shipped as a single unit that includes the choke according to any of examples 1-19.

Example 21. A method comprising: while providing a choke system according to any of examples 1-20 in a closed configuration, (a) providing a first pressure in the input channel and second pressure in the output channel while the chose system , wherein the first pressure is higher than the second pressure, (b) providing a third pressure in the input channel and fourth pressure in the output channel, wherein the fourth pressure is higher than the third pressure; wherein providing the third pressure in the input channel occurs after or before providing the first pressure in the input channel.

### EXAMPLE SET 3

Example 1. A choke system comprising: a choke body including an input channel, an output channel, a seat, and a gate; a valve stem coupled to the gate; a choke valve actuator; a threaded first rod that couples the choke valve actuator to the valve stem; a plurality of anchors that couple the choke valve actuator to the choke body; wherein a first axis is colinear with a long axis of the valve stem; wherein the seat includes a seat channel that couples the input channel to the output channel; wherein the plurality of anchors includes at least four anchors that are equidistant from the first axis in a plane that is orthogonal to the first axis.

Example 2. The system of example 1 comprising a conduit that couples the choke valve actuator to the choke body, wherein: the conduit includes a flange; the first rod is at least partially included in both the choke valve actuator and the conduit; the choke body is coupled to the flange via the plurality of anchors and no other anchors couple the flange to the choke body.

Example 3. The system of example 2, wherein: the conduit includes an additional flange; the choke valve actuator is coupled to the additional flange via an additional plurality of anchors and no other anchors couple the additional flange to the choke valve actuator; the additional plurality of anchors includes at least four anchors that are equidistant from the first axis in an additional plane that is orthogonal to the first axis.

Example 4. The system of example 2, wherein: the conduit includes a channel having a non-circular circumference; the first rod includes a non-threaded portion having a circumference that pattern matches the non-circular circumference of the channel of the conduit.

Example 5. The system of example 4, wherein: the non-circular circumference includes first, second, and third linear portions that are not co-linear with one another; the second linear portion directly interfaces the first and third linear portions.

Example 6. The system of example 1, wherein: the choke valve actuator includes a worm drive; the first rod is a part of the worm drive.

Example 7. The system of example 1, comprising: a housing having a window; a mechanical gauge; wherein the mechanical gauge is: (a) withdrawn away from the seat to visually indicate, via the window, the choke system is in an open configuration, (b) advanced towards the seat to engage the gate with the seat to visually indicate, via the window, the choke system is in a closed configuration.

Example 8. The system of example 1 comprising a second rod that couples the first rod to the valve stem.

Example 9. The system of example 8, wherein: the first rod includes a threaded upper end and a non-threaded lower end, the non-threaded lower end of the first rod being between the threaded upper end of the first rod and the gate; the second rod includes an upper end and a lower end, the lower end of the second rod being between the upper end of the second rod and the gate; and a second axis is parallel to the first axis; the second axis intersects the upper end of the second rod at a first location and the non-threaded lower end of the first rod at second and third locations; and the first location is between the second and third locations.

Example 10. The system of example 1, wherein: the valve stem includes a valve stem channel, a valve stem first aperture, and a valve stem second aperture; the valve stem channel couples the valve stem first aperture to the valve stem second aperture; the valve stem channel is hollow; the valve stem second aperture is in a sidewall of the valve stem.

Example 11. The system of example 10, wherein: the valve stem includes an valve stem additional channel, a valve stem additional first aperture, and a valve stem additional second aperture; the valve stem additional channel couples the valve stem additional first aperture to the valve stem additional second aperture; the valve stem additional channel is hollow; the valve stem additional second aperture is in a sidewall of the valve stem.

Example 12. The system of example 11, wherein: the valve stem includes outer portions that join at a junction location; the outer portions join at the junction location at an angle that is between 85 and 95 degrees; the junction location is between the valve stem second aperture and the valve stem additional second aperture.

Example 13. The system of example 12, wherein the junction location is within 5 mm of the gate.

Example 14. The system of example 1 comprising an additional rod threadingly coupled to the valve stem, wherein: the additional rod includes an additional rod channel, an additional rod first aperture, and an additional rod second aperture; the additional rod channel couples the additional rod first aperture to the additional rod second aperture; the additional rod channel is hollow; the additional rod second aperture is in a sidewall of the additional rod.

Example 15. The system of example 1 comprising: stem packing in contact with the valve stem; a choke body cylinder that includes at least a portion of the valve stem, a cylinder channel, a cylinder first aperture, and a cylinder second aperture; the cylinder channel couples the cylinder first aperture to the cylinder second aperture; the cylinder channel is hollow; the cylinder first aperture fluidly couples the stem packing to the cylinder channel; the cylinder second aperture is in a sidewall of the choke body cylinder.

Example 16. The system of example 1 comprising a choke body seal, wherein: the choke body seal directly contacts an inner wall of the choke body; the choke body includes a choke body channel, a choke body first aperture, and a choke body second aperture; the choke body channel couples the choke body first aperture to the choke body second aperture; the choke body channel is hollow; the choke body first aperture fluidly couples the choke body seal to the choke body channel; the choke body second aperture is in a sidewall of the choke body.

Example 17. The system of example 1, wherein: the gate includes a gate channel that traverses the gate and terminates at a gate channel aperture; the gate channel aperture is within 5 mm of a portion of the valve stem; at least a portion of the gate channel aperture is not blocked by the valve stem or any other component of the system; no portion of the valve stem is included in the gate channel.

Example 18. The system of example 1, wherein: the gate includes a gate channel in a wall of the gate, the gate channel traversing the gate and terminating at a gate channel aperture; the gate channel aperture is within 5 mm of a portion of the valve stem.

Example 19. The system of example 18, wherein at least a portion of the gate channel aperture is blocked by the valve stem or any other component of the system.

Example 20. The system of example 1 comprising: at least one gate valve coupled to the choke body; at least one additional choke coupled to the choke body.

The foregoing description of the embodiments of the invention has been presented for the purposes of illustration and description. It is not intended to be exhaustive or to limit the invention to the precise forms disclosed. This description and the claims following include terms, such as left, right, top, bottom, over, under, upper, lower, first, second, etc. that are used for descriptive purposes only and are not to be construed as limiting. For example, terms designating relative vertical position refer to a situation where a device side is the "top" surface of that device; the device may actually be in any orientation so that a "top" side of a substrate may be lower than the "bottom" side in a standard terrestrial frame of reference and still fall within the meaning of the term "top." The embodiments of a device or article described herein can be manufactured, used, or shipped in a number of positions and orientations. Persons skilled in the relevant art can appreciate that many modifications and variations are possible in light of the above teaching. Persons skilled in the art will recognize various equivalent combinations and substitutions for various components shown in the Figures. It is therefore intended that the scope of the invention be limited not by this detailed description, but rather by the claims appended hereto.

What is claimed is:

1. A choke system comprising:
a choke body including an input channel, an output channel, a seat, and a gate;
a valve stem coupled to the gate;
a choke valve actuator;
a threaded first rod that couples the choke valve actuator to the valve stem;
a plurality of anchors that couple the choke valve actuator to the choke body;
wherein a first axis is colinear with a long axis of the valve stem;
wherein the seat includes a seat channel that couples the input channel to the output channel;
wherein the plurality of anchors includes at least four anchors that are equidistant from the first axis in a plane that is orthogonal to the first axis.

2. The system of claim 1 comprising a conduit that couples the choke valve actuator to the choke body, wherein:
the conduit includes a flange;
the first rod is at least partially included in both the choke valve actuator and the conduit;
the choke body is coupled to the flange via the plurality of anchors and no other anchors couple the flange to the choke body.

3. The system of claim 2, wherein:
the conduit includes an additional flange;
the choke valve actuator is coupled to the additional flange via an additional plurality of anchors and no other anchors couple the additional flange to the choke valve actuator;
the additional plurality of anchors includes at least four anchors that are equidistant from the first axis in an additional plane that is orthogonal to the first axis.

4. The system of claim 2, wherein:
the conduit includes a channel having a non-circular circumference;
the first rod includes a non-threaded portion having a circumference that pattern matches the non-circular circumference of the channel of the conduit.

5. The system of claim 4, wherein:
the non-circular circumference includes first, second, and third linear portions that are not co-linear with one another;
the second linear portion directly interfaces the first and third linear portions.

6. The system of claim 1, wherein:
the choke valve actuator includes a worm drive;
the first rod is a part of the worm drive.

7. The system of claim 1, comprising:
a housing having a window;
a mechanical gauge;
wherein the mechanical gauge is: (a) withdrawn away from the seat to visually indicate, via the window, the choke system is in an open configuration, (b) advanced towards the seat to engage the gate with the seat to visually indicate, via the window, the choke system is in a closed configuration.

8. The system of claim 1 comprising a second rod that couples the first rod to the valve stem.

9. The system of claim 8, wherein:
the first rod includes a threaded upper end and a non-threaded lower end, the non-threaded lower end of the first rod being between the threaded upper end of the first rod and the gate;
the second rod includes an upper end and a lower end, the lower end of the second rod being between the upper end of the second rod and the gate; and
a second axis is parallel to the first axis;
the second axis intersects the upper end of the second rod at a first location and the non-threaded lower end of the first rod at second and third locations; and
the first location is between the second and third locations.

10. The system of claim 1, wherein:
the valve stem includes a valve stem channel, a valve stem first aperture, and a valve stem second aperture;
the valve stem channel couples the valve stem first aperture to the valve stem second aperture;
the valve stem channel is hollow;
the valve stem second aperture is in a sidewall of the valve stem.

11. The system of claim 10, wherein:
the valve stem includes an valve stem additional channel, a valve stem additional first aperture, and a valve stem additional second aperture;
the valve stem additional channel couples the valve stem additional first aperture to the valve stem additional second aperture;
the valve stem additional channel is hollow;
the valve stem additional second aperture is in a sidewall of the valve stem.

12. The system of claim 11, wherein:
the valve stem includes outer portions that join at a junction location;
the outer portions join at the junction location at an angle that is between 85 and 95 degrees;
the junction location is between the valve stem second aperture and the valve stem additional second aperture.

13. The system of claim 12, wherein the junction location is within 5 mm of the gate.

14. The system of claim 1 comprising an additional rod threadingly coupled to the valve stem, wherein:
the additional rod includes an additional rod channel, an additional rod first aperture, and an additional rod second aperture;
the additional rod channel couples the additional rod first aperture to the additional rod second aperture;
the additional rod channel is hollow;
the additional rod second aperture is in a sidewall of the additional rod.

15. The system of claim 1 comprising:
stem packing in contact with the valve stem;
a choke body cylinder that includes at least a portion of the valve stem, a cylinder channel, a cylinder first aperture, and a cylinder second aperture;
the cylinder channel couples the cylinder first aperture to the cylinder second aperture;
the cylinder channel is hollow;
the cylinder first aperture fluidly couples the stem packing to the cylinder channel;
the cylinder second aperture is in a sidewall of the choke body cylinder.

16. The system of claim 1 comprising a choke body seal, wherein:
the choke body seal directly contacts an inner wall of the choke body;
the choke body includes a choke body channel, a choke body first aperture, and a choke body second aperture;
the choke body channel couples the choke body first aperture to the choke body second aperture;
the choke body channel is hollow;
the choke body first aperture fluidly couples the choke body seal to the choke body channel;
the choke body second aperture is in a sidewall of the choke body.

17. The system of claim 1, wherein:
the gate includes a gate channel that traverses the gate and terminates at a gate channel aperture;
the gate channel aperture is within 5 mm of a portion of the valve stem;
at least a portion of the gate channel aperture is not blocked by the valve stem or any other component of the system;
no portion of the valve stem is included in the gate channel.

18. The system of claim 1, wherein:
the gate includes a gate channel in a wall of the gate, the gate channel traversing the gate and terminating at a gate channel aperture;
the gate channel aperture is within 5 mm of a portion of the valve stem.

19. The system of claim 18, wherein at least a portion of the gate channel aperture is blocked by the valve stem or any other component of the system.

20. The system of claim 1 comprising:
at least one gate valve coupled to the choke body;
at least one additional choke coupled to the choke body.
